(19) United States
(12) Patent Application Publication
(10) Pub. No.: US 2004/0099979 A1
(43) Pub. Date: May 27, 2004

(54) Process for preparing porous material having interconnected pores

(76) Inventors: Jui-Hsiang Chen, Hsinchu (TW); Jean-Dean Yang, Taoyuan (TW); Muh-Lan Chen, Hsinchu City (TW); Kei-Hung Wu, Nanchuang Township (TW); Bin-Hong Tsai, Kaohsiung (TW); Mei-Jun Liu, Miaoli (TW); Yu-Lin Hsieh, Kaohsiung (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/713,420

(22) Filed: Nov. 14, 2003

Related U.S. Application Data
(63) Continuation-in-part of application No. 10/038,419, filed on Jan. 2, 2002, now abandoned.

(30) Foreign Application Priority Data
Jul. 18, 2003 (TW) 92119629

(51) Int. Cl. B29C 67/20; B29C 71/00; B29C 71/02

(52) U.S. Cl. 264/41; 264/233; 264/234

(57) ABSTRACT

The present invention provides a process for preparing a porous material having interconnected pores. One or more kinds of bioresorbable polymers and a low molecular weight oligomer are dissolved in an organic solvent to form a bioresorbable polymer solution. The bioresorbable polymer solution is then exposed to a coagulant to form a porous material. The low molecular weight oligomer is soluble in the coagulant, and the bioresorbable polymer is insoluble in the coagulant.

### CROSS REFERENCE TO RELATED APPLICATIONS

This application is a continuation-in-part of application Ser. No. 10/038,419 filed on Jan. 2, 2002, now pending.

### BACKGROUND OF THE INVENTION

1. Field of the Invention

The present invention relates to a process for preparing porous material having interconnected pores, and more particularly to a process for preparing porous material having interconnected pores by means of using a low molecular weight oligomer as a pore former, forming a pre-form of a bioresorbable polymer, drying, and then coagulating the pre-form.

2. Description of the Related Art

Materials that serve as analogues for a native extracellular matrix may have uses in medicine or dentistry, and may aid in the reconstruction or regeneration of bone, cartilage, liver, skin and other tissue. The so-called bioresorbable polymers, which degrade in the body by hydrolysis into smaller molecular weight compounds that can be absorbed by biological tissues, are potential materials for fabricating such analogues. Implanting biomaterials or biodevices prepared from such bioresorbable polymers in the human body decreases undesirable foreign body reaction.

Naturally occurring bioresorbable polymers include collagen, gelatin, silk, chitosan, chitin, alginate, hyaluronic acid, and chondroitin sulphate. Synthetic bioresorbable polymers include polyglycolic acid (PGA), polylactic acid (PLA), poly (glycolic-co-lactic acid (PLGA), polycaprolactone (PCL), and polydioxane. Many of the above bioresorbable polymers have been used clinically to fabricate implantable biomaterials or biodevices. For example, PGA has been used to fabricate bioresorbable sutures, bioresorbable bone screws, and internal fixative devices.

In some clinical conditions, the bioresorbable polymer is fabricated into a porous matrix, also referred to as a “scaffold”. Generally, cells cultured in vitro are adhered to the surface of the porous matrix and grown for a period of time. The porous matrix containing living cells is then implanted into a patient body. The implanted cells grow in the body and gradually form a tissue with specific functions, such as cartilage, bone, muscle, and blood vessels.

Many processes have been proposed for fabricating a bioresorbable porous matrix, which can be classified into the following eight categories: (1) solution casting, (2) solvent-casting particulate leaching, (3) gel casting, (4) gas saturation, (5) phase separation, (6) bonded fiber, (7) particle sintering, , and (8) foaming agent.

Widmer et al. (Biomaterials, 19, p.1945-1955, 1998) and Evans et al. (Biomaterials, 20, p.1109-1115, 1999) use PLGA and PLLA polymers which were dissolved in methylene chloride. A ground salt is added to the polymer solution, stirred thoroughly, cooled, cut into small pieces, and extruded into hollow round tubes. The tubes are then cut and immersed in water for 24 hours to form porous round tubes.

Groot et al. (Biomaterials, 18, p.613-622, 1997) use 50/50 copoly (L-lactide/ε-caprolactone) dissolved in a mixed solvent of 1,4-dioxane and c-hexane (90/10). Saccharose crystals are then added to the solution, stirred thoroughly, frozen at −15° C., evaporated under reduced pressure to remove solvent, and washed with water to remove saccharose crystals and obtain a porous material.

Ishaug-Riley et al. (Biomaterials, 19, p.1405-1412, 1998) use the solvent-casting particulate-leaching method to prepare a porous material by employing 75:25 poly(DL-lactic-co-glycolic acid) (PLGA) as the bioresorbable polymer source.

Thomson et al. (Biomaterials, 20, p.2007-2018, 1999) use the solvent-casting and salt-leaching methods to prepare a porous material by employing 85:15 poly(DL-lactic-co-glycolic acid (PLGA) as the bioresorbable polymer source.

Schindler in U.S. Pat. No. 4,702,917 discloses a process for preparing porous bioresorbable polyester. Bioresorbable polymers (polycaprolactone and polyoxypropylene) are melted and then cooled to form a solidified material. The solvent extraction process is then performed to remove polyoxypropylene to form a bioresorbable porous polyester material.

Ashman in U.S. Pat. No. 4,199,864 discloses a process for preparing an implantable porous film. A monomer and soluble salt (such as NaCl) crystals are mixed. Polymerization is conducted by heating. The salt crystals are then leached out with water to form a porous film.

Mikos et al. in U.S. Pat. No. 5,514,378 disclose a process for preparing a polymer membrane having a three dimensional structure. A polymer is dissolved in a solvent to form a polymer solution. Salt particles are added to the polymer solution and then poured into a mold. The polymer solution containing salt particles is heated to remove the solvent to form a polymer membrane. The polymer membrane is then placed in water or other solvent that dissolves the salt particles for a suitable time. Subsequently the salt particles are leached out, and a polymer membrane having a three dimensional structure is thus obtained.

### SUMMARY OF THE INVENTION

An object of the present invention is to solve the above-mentioned problems and provide a process for preparing a porous material having interconnected pores.

To achieve the above-mentioned object, the process of the present invention includes the following steps. First, one or more kinds of bioresorbable polymers and a low molecular weight oligomer are dissolved in an organic solvent to form a bioresorbable polymer solution. Next, the bioresorbable polymer solution is exposed to a coagulant to form the porous material. The low molecular weight oligomer is soluble in the coagulant, and the bioresorbable polymer is insoluble in the coagulant.

According to a preferred embodiment of the present invention, the process of the present invention includes the following steps. First, one or more kinds of bioresorbable polymers and a low molecular weight oligomer are dissolved in an organic solvent to form a bioresorbable polymer solution. The bioresorbable polymer solution then forms a pre-form. The pre-form is then dried to partially or completely remove the organic solvent on the pre-form surface. Finally, the pre-form is exposed to a coagulant to form the porous material. The low molecular weight oligomer is soluble in the coagulant, while the bioresorbable polymer is insoluble in the coagulant.

According to a first aspect of the present invention, a low molecular weight oligomer is added to the bioresorbable polymer solution as a pore former. Since the oligomer has a considerable molecular weight, it diffuses into the coagulant at a slower rate in the coagulation process of the bioresorbable polymer solution. In this manner, the bioresorbable polymer can be formed into a porous material having interconnected pores.

According to a second aspect of the present invention, after the pre-form is formed, drying is performed before exposure to coagulant. Thus, the surface of the pre-form is solidified. This ensures that the pre-form will have a more fixed shape and better film forming properties. Thus, when the pre-form is placed in the coagulant, it will not break up in the coagulant, but keep an integral structure.

According to a third aspect of the present invention, two or more kinds of bioresorbable polymers with different degradation rates can be used. Thus, the degradation rate of the obtained porous material can be controlled by adjusting the blending ratio of the different bioresorbable polymers.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIGS. 1A and 1B are schematic diagrams showing the water permeation test according to the example of the present invention, wherein the glass container is placed with the opening upward in FIG. 1A and placed upside down in FIG. 1B.

FIGS. 2A to 2D are SEM photographs of the porous PCL material obtained from Example 1 of the present invention, wherein the magnification of FIGS. 2A to 2C is 2000×, and the magnification of FIG. 2D is 1500×.

FIGS. 3A to 3D are SEM photographs of the porous PCL material obtained from Example 5 of the present invention, wherein the magnification of FIGS. 3A to 3D is 5000×, 1500×, 2000×, and 1500× respectively.

FIGS. 4A and 4B are SEM photographs of the porous PCL material obtained from Example 15 of the present invention, wherein the magnification of FIGS. 4A and 4B is 350× and 500× respectively.

FIGS. 5A to 5C are SEM photographs of the porous PCL/PLA mixed material obtained from Example 23 of the present invention, wherein the magnification of FIGS. 5B and 5C is 800× and 1200× respectively. FIG. 5A shows that the blended solution untreated by surface solidification cannot be coagulated in the coagulant.

FIGS. 6A to 6C are SEM photographs of the porous PCL/PLA mixed material obtained from Example 24 of the present invention, wherein the magnification of FIGS. 6A to 6C is 1500×, 3000×, and 950× respectively.

FIG. 7 is an SEM photograph of the porous PCL/PLGA mixed material obtained from Example 25 of the present invention, wherein the magnification is 1500×.

### DETAILED DESCRIPTION OF THE INVENTION

The present invention provides a novel process for preparing a porous material having interconnected pores. One or more kinds of bioresorbable polymers and a low molecular weight oligomer are dissolved in an organic solvent to form a bioresorbable polymer solution. Then, the bioresorbable polymer solution is exposed to a coagulant to form a porous material.

Before the coagulating step, the bioresorbable polymer solution can form a pre-form, for example, a thin film of 0.1 mm to 5 mm thick, by coating the solution on a mold surface or by pouring the solution into a container. The pre-form can then be dried to partially or completely remove the organic solvent on the pre-form surface. For example, a flat plate-shaped mold coated with the bioresorbable pre-form or a container loaded with the bioresorbable pre-form can be held still in air to evaporate the solvent on the surface and coagulate the pre-form.

After drying, the flat plate-shaped mold coated with the bioresorbable pre-form or the container loaded with the bioresorbable pre-form is placed in a coagulant to form a porous polymer material. The pre-form is preferably exposed to the coagulant (or the bioresorbable polymer solution when a pre-form is not formed) at a temperature of 5° C. to 60° C., and more preferably at a temperature of 10° C. to 50° C.

The mold and container can be made of any material, for example, polymer, inorganic ceramics, or metal.

The present invention uses one or more kinds of bioresorbable polymers to prepare a porous material. The suitable bioresorbable polymer can have a molecular weight higher than 20,000, and preferably ranging from 20,000 to 1,500,000. The low molecular weight oligomer can have a molecular weight of 200 to 10000, and preferably 200 to 5000.

According to the present invention, a suitable bioresorbable polymer can be polycaprolactone (PCL), polylactic acid (PLA), poly-L-lactide (PLLA), polyglycolic acid (PGA), poly-lactic-co-glycolic acid copolymer (PLGA copolymer), polycaprolactone-polylactic acid copolymer (PCL-PLA copolymer), polycaprolactone-polyethylene glycol copolymer (PCL-PEG copolymer), or mixtures thereof.

The low molecular weight oligomer suitable for use can be bioresorbable or non-bioresorbable. Representative examples include polycaprolactone triol (PCLTL), polycaprolactone diol (PCLDL), polycaprolactone (PCL), polylactic acid (PLA), polyethylene glycol (PEG), polypropylene glycol (PPG), polytetramethylene glycol (PTMG), and mixtures thereof.

According to the present invention, the organic solvent for dissolving the bioresorbable polymer and low molecular weight oligomer can be N,N-dimethylformamide (DMF), N,N-dimethylacetamide (DMAc), THF, alcohols, chloroform, dichloromethane (DCM), 1,4-dioxane, or mixtures thereof. The bioresorbable polymer can be present in an amount of 5-70%, more preferably 10-50%, weight fraction of the bioresorbable polymer solution. The low molecular weight oligomer can be present in an amount of 10-80% weight fraction based on the non-solvent portion of the bioresorbable polymer solution.

According to the present invention, the above coagulant is preferably water, an organic solvent, a mixture of water and an organic solvent, or a mixture of organic solvents. Preferably, the coagulant includes water and an organic solvent, and the organic solvent in the coagulant can be present in an amount of 5-90% weight fraction. The organic solvent in the coagulant can be an amide, a ketone, an alcohol, or a mixture thereof. Preferably, the organic solvent in the coagulant includes a ketone and an alcohol.

Representative examples of the organic solvent in the coagulant include N,N-dimethylformamide (DMF), N,N-dimethylacetamide (DMAc), tetrahydrofuran (THF), ketones such as acetone and methyl ethyl ketone (MEK), and alcohols such as methanol, ethanol, propanol, isopropanol, and butanol.

In the present invention, the organic solvent used for preparing the bioresorbable polymer solution is a good solvent to the bioresorbable polymer. The organic solvent in the bioresorbable polymer solution exchanges with the bad solvent in the coagulant through diffusion. Thus, the polymer material gradually precipitates to form a matrix with a certain extent of foaming. This is the so-called phase separation method. Conventionally, the material formed only by exchange between good solvent and bad solvent has low porosity and is non-uniform. Also, the pores have a non-interconnected closed cell form.

However, the present invention does not simply use the phase separation method. According to a first feature of the present invention, a low molecular weight oligomer is added to the bioresorbable polymer solution. Since the oligomer has a considerable molecular weight, it diffuses into the coagulant at a slower rate in the coagulation process of the bioresorbable polymer solution. In this manner, the bioresorbable polymer can be formed into a porous material having interconnected pores. Therefore, the low molecular weight oligomer acts as a pore former in the present invention. The porosity and pore size of the finally formed porous material can be adjusted by choosing the species and molecular weight of the low molecular weight oligomer and the content in the bioresorbable polymer solution.

According to the present invention, after the bioresorbable polymer solution is formed into a pre-form, drying is performed to partially or completely remove the organic solvent on the pre-form surface. Next, the pre-form is exposed to the coagulant. The coagulant removes the residual organic solvent and low molecular weight oligomer in the pre-form (or in the bioresorbable polymer solution) to diffuse and dissolve in the coagulant. In contrast, the high molecular weight bioresorbable polymer does not dissolve in the coagulant, thus forming a porous material having interconnected pores.

According to a second feature of the present invention, after the pre-form is formed, drying is performed before exposure to coagulant. Thus, the surface of the pre-form is solidified. This ensures that the pre-form will have a more fixed shape and better film forming properties. Thus, when the pre-form is placed in the coagulant, it will not break up in the coagulant, but keep an integral structure.

The drying step suitable in the present invention is not limited, as long as the organic solvent on the pre-form surface can be partially or completely removed. Preferably, drying causes the pre-form to form a gel or tack-free surface. Drying can be conducted in air at room temperature, by heating, in an oven, at reduced pressure, or by radiation.

According to a third aspect of the present invention, two or more kinds of bioresorbable polymers with different degradation rates together with a low molecular weight oligomer can be commonly dissolved in an organic solvent. Thus, the degradation rate of the obtained porous material can be controlled by adjusting the blending ratio of the different bioresorbable polymers.

After the pre-form (or the bioresorbable polymer solution) is exposed to the coagulant, the obtained porous material is preferably placed in a washing liquid. The washing liquid can be water, an organic solvent, a mixture of water and an organic solvent, or a mixture of organic solvents, and the organic solvent can be a ketone, an alcohol, or a mixture thereof. Representative examples of the ketone include acetone and methyl ethyl ketone (MEK). Representative examples of the alcohol include methanol, ethanol, propanol, isopropanol and butanol.

The following examples are intended to illustrate the process and the advantages of the present invention more fully without limiting its scope, since numerous modifications and variations will be apparent to those skilled in the art.

### EXAMPLE 1

15 g of polycaprolactone (PCL) having a molecular weight about 80,000 and 15 g of polyethylene glycol (PEG) having a molecular weight of 1000 (an oligomer) were added to 70 g of THF, which was stirred thoroughly at room temperature to form a PCL solution containing PEG oligomer. The solution was then coated onto the surface of a plate-shaped mold to a thickness of about 0.5 mm. The plate-shaped mold coated with PCL solution was then placed in a coagulant at 25° C. (the composition of the coagulant and coagulating time are shown in Table 1). Thus, the PCL solution was coagulated to form a porous PCL material. The porous PCL material was then immersed in a 50% acetone solution (washing liquid) for 2 hours, and then washed with clean water and dried to obtain the final flat film-shaped porous PCL material.

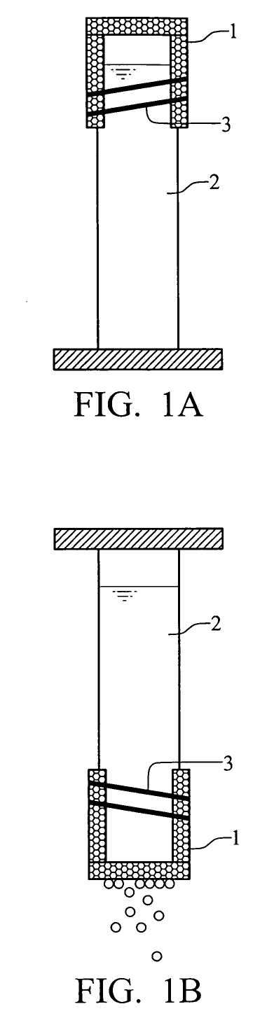

The following procedures were conducted in order to determine whether the flat film-shaped porous PCL material has an interconnected pore structure. Referring to FIG. 1A, the flat film-shaped porous PCL material 1 was covered over a glass container 2 loaded with water to seal the container 2. The PCL material 1 was fixed to the container 2 with, for example, a rubber band 3. Then, the container 2 was turned upside down as shown in FIG. 1B. After a few seconds, water in the container 2 gradually penetrated through the porous PCL material 1. Such a water penetration test proved that the obtained PCL flat film had interconnected pores.

Specimens 1A, 1B, 1C, and 1D were observed by SEM (scanning electron microscope) to doubly assure that the PCL flat film obtained was a material having an interconnected pore structure.

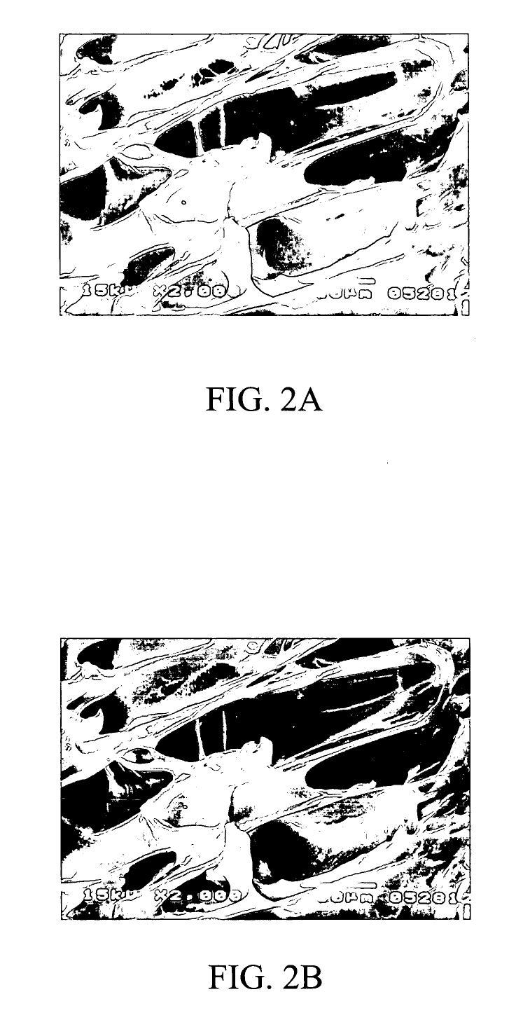

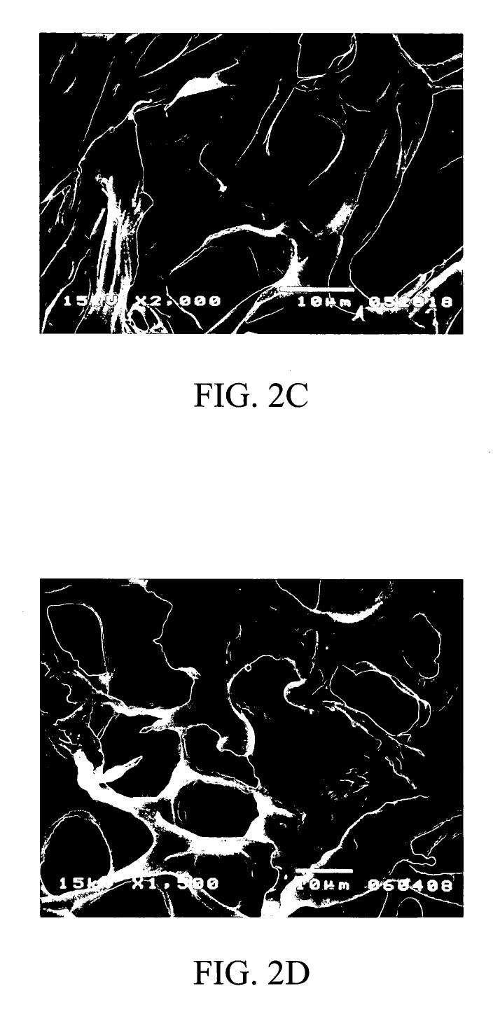

TABLE 1

| | | | Porous | |
|---|---|---|---|---|
| | | Coagulating | structure of | |
| Specimen | Coagulant | time (hr) | porous matrix | SEM photo |
| 1A | 40 wt % | 4 | interconnected | |
| | acetone | | | |
| 1B | 40 wt % | 4 | interconnected | |
| | ethanol | | | |
| 1C | 60 wt % | 4 | interconnected | |
| | ethanol | | | |
| 1D | 20 wt % DMF | 4 | interconnected | FIG. 2D |

### EXAMPLE 2

15 g of polycaprolactone (PCL) having a molecular weight about 80,000 and 15 g of polypropylene glycol (PPG) having a molecular weight of 1000 (an oligomer) were added to 70 g of THF, which was stirred thoroughly at room temperature to form a PCL solution. The solution was then coated onto the surface of a plate-shaped mold to a thickness of about 0.5 mm. The plate-shaped mold coated with PCL solution was then placed in a coagulant at 25° C. (the composition of the coagulant and coagulating time are shown in Table 2). Thus, the PCL solution was coagulated to form a porous PCL material. The porous PCL material was then immersed in a 50% acetone solution (washing liquid) for 2 hours, and then washed with clean water and dried to obtain the final flat film-shaped porous PCL material. The flat film-shaped porous PCL material obtained was tested by the water permeation test to confirm that the PCL flat film was a material having an interconnected pore structure.

TABLE 2

| | | | Pore structure |
|---|---|---|---|
| | | Coagulating | of porous |
| Specimen | Coagulant | time (hr) | matrix |
| 2A | 40 wt % | 3 | interconnected |
| | acetone | | |
| 2B | 40 wt % | 3 | interconnected |
| | ethanol | | |
| 2C | 60 wt % | 3 | interconnected |
| | ethanol | | |
| 2D | 20 wt % DMF | 3 | interconnected |

### EXAMPLE 3

15 g of polycaprolactone (PCL) having a molecular weight about 80,000 and 15 g of polytetramethylene glycol (PTMG) having a molecular weight of 1000 (an oligomer) were added to 70 g of THF, which was stirred thoroughly at room temperature to form a PCL solution. The solution was then coated onto the surface of a plate-shaped mold to a thickness of about 0.5 mm. The plate-shaped mold coated with PCL solution was then placed in a coagulant at 25° C. (the composition of the coagulant and coagulating time are shown in Table 3). Thus, the PCL solution was coagulated to form a porous PCL material. The porous PCL material was then immersed in a 50% acetone solution (washing liquid) for 2 hours, and then washed with clean water and dried to obtain the final flat film-shaped porous PCL material. The flat film-shaped porous PCL material obtained was tested by the water permeation test to confirm that the PCL flat film was a material having an interconnected pore structure.

TABLE 3

| | | | Pore structure |
|---|---|---|---|
| | | Coagulating | of porous |
| Specimen | Coagulant | time (hr) | matrix |
| 3A | 40 wt % | 2 | interconnected |
| | acetone | | |
| 3B | 40 wt % | 2 | interconnected |
| | ethanol | | |
| 3C | 60 wt % | 2 | interconnected |
| | ethanol | | |
| 3D | 20 wt % DMF | 2 | interconnected |

### EXAMPLE 4

15 g of polycaprolactone (PCL) having a molecular weight about 80,000 and 15 g of polycaprolactone triol (PCLTL) having a molecular weight of 300 (an oligomer) were added to 70 g of THF, which was stirred thoroughly at room temperature to form a PCL solution. The solution was then coated onto the surface of a plate-shaped mold to a thickness of about 0.5 mm. The plate-shaped mold coated with PCL solution was then placed in a coagulant at 25° C. (the composition of the coagulant and coagulating time are shown in Table 4). Thus, the PCL solution was coagulated to form a porous PCL material. The porous PCL material was then immersed in a 50% acetone solution (washing liquid) for 2 hours, and then washed with clean water and dried to obtain the final flat film-shaped porous PCL material. The flat film-shaped porous PCL material obtained was tested by the water permeation test to confirm that the PCL flat film was a material having an interconnected pore structure.

TABLE 4

| | | | Pore structure |
|---|---|---|---|
| | | Coagulating | of porous |
| Specimen | Coagulant | time (hr) | matrix |
| 4A | 40 wt % | 4 | interconnected |
| | acetone | | |
| 4B | 40 wt % | 4 | interconnected |
| | ethanol | | |
| 4C | 60 wt % | 4 | interconnected |
| | ethanol | | |
| 4D | 20 wt % DMF | 4 | interconnected |

### EXAMPLE 5

15 g of polycaprolactone (PCL) having a molecular weight about 80,000 and 15 g of polyethylene glycol (PEG) having a molecular weight of 1000 (an oligomer) were added to 70 g of DMF, which was stirred thoroughly at room temperature to form a PCL solution. The solution was then coated onto the surface of a plate-shaped mold to a thickness of about 0.5 mm. The plate-shaped mold coated with PCL solution was then placed in a coagulant at 20° C. (the composition of the coagulant and coagulating time are shown in Table 5). Thus, the PCL solution was coagulated to form a porous PCL material. The porous PCL material was then immersed in a 50% acetone solution (washing liquid) for 2 hours, and then washed with clean water and dried to obtain the final flat film-shaped porous PCL material. The flat film-shaped porous PCL material obtained was tested by the water permeation test to confirm that the PCL flat film was a material having an interconnected pore structure.

Specimens 5A, 5B, 5C, and 5D were observed by SEM (scanning electron microscope) to doubly assure that the PCL flat film obtained was a material having an interconnected pore structure.

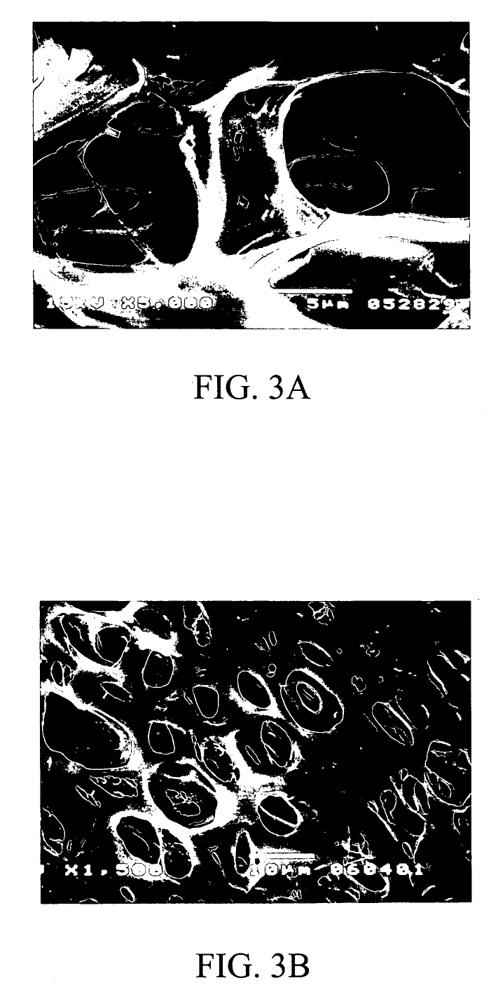

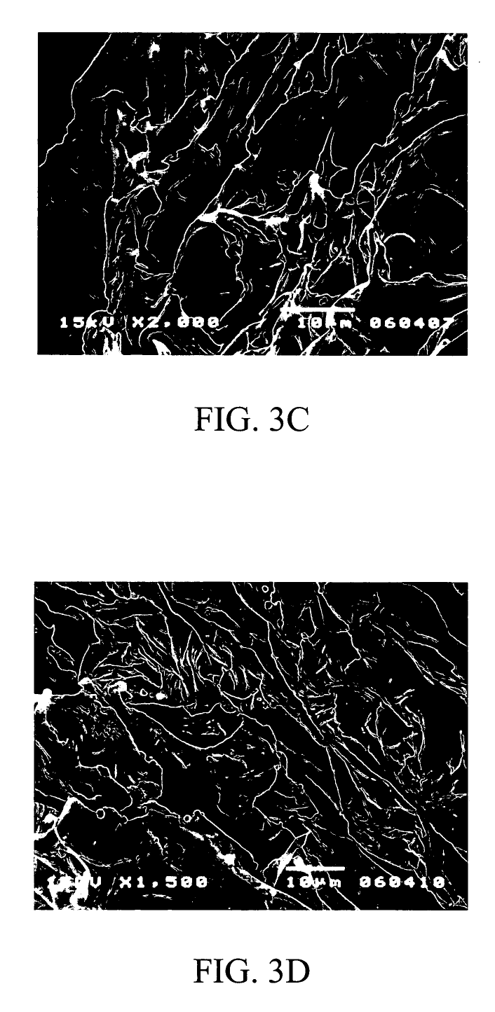

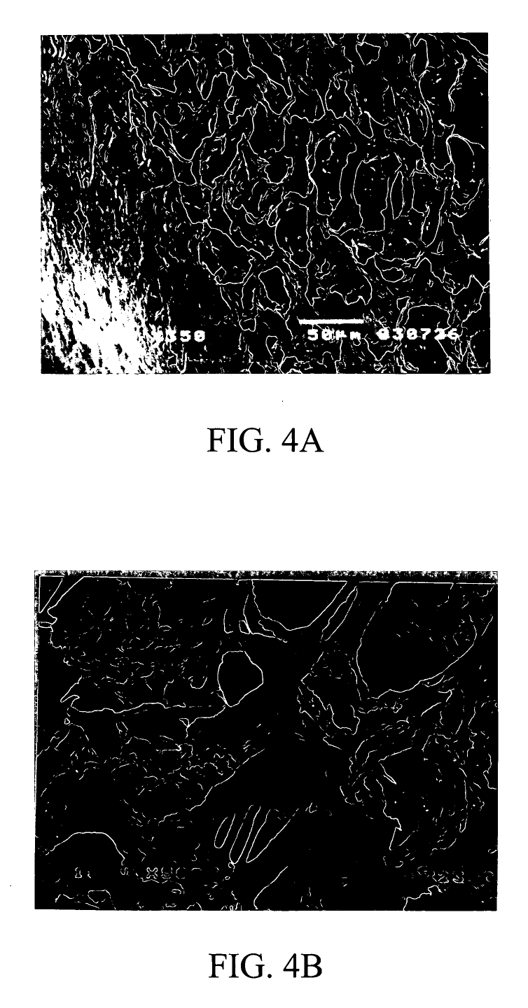

TABLE 5

| | | Coagulating | Porous structure | SEM |
|---|---|---|---|---|
| Specimen | Coagulant | time (hr) | of porous matrix | photo |
| 5A | 40 wt % | 3 | interconnected | |
| | acetone | | | |
| 5B | 40 wt % | 3 | interconnected | |
| | ethanol | | | |
| 5C | 60 wt % | 3 | interconnected | |
| | ethanol | | | |
| 5D | 20 wt % DMF | 3 | interconnected | FIG. 3D |

### EXAMPLE 6

15 g of polycaprolactone (PCL) having a molecular weight about 80,000 and 15 g of polypropylene glycol (PPG) having a molecular weight of 1000 (an oligomer) were added to 70 g of DMF, which was stirred thoroughly at room temperature to form a PCL solution. The solution was then coated onto the surface of a plate-shaped mold to a thickness of about 0.5 mm. The plate-shaped mold coated with PCL solution was then placed in a coagulant at 20° C. (the composition of the coagulant and coagulating time are shown in Table 6). Thus, the PCL solution was coagulated to form a porous PCL material. The porous PCL material was then immersed in a 50% acetone solution (washing liquid) for 2 hours, and then washed with clean water and dried to obtain the final flat film-shaped porous PCL material. The flat film-shaped porous PCL material obtained was tested by the water permeation test to confirm that the PCL flat film was a material having an interconnected pore structure.

TABLE 6

| | | | Pore structure |
|---|---|---|---|
| | | Coagulating | of porous |
| Specimen | Coagulant | time (hr) | matrix |
| 6A | 40 wt % | 2 | interconnected |
| | acetone | | |
| 6B | 40 wt % | 2 | interconnected |
| | ethanol | | |
| 6C | 60 wt % | 2 | interconnected |
| | ethanol | | |
| 6D | 20 wt % DMF | 2 | interconnected |

### EXAMPLE 7

15 g of polycaprolactone (PCL) having a molecular weight about 80,000 and 15 g of polytetramethylene glycol (PTMG) having a molecular weight of 1000 (an oligomer) were added to 70 g of DMF, which was stirred thoroughly at room temperature to form a PCL solution. The solution was then coated onto the surface of a plate-shaped mold to a thickness of about 0.4 mm. The plate-shaped mold coated with PCL solution was then placed in a coagulant at 20° C. (the composition of the coagulant and coagulating time are shown in Table 7). Thus, the PCL solution was coagulated to form a porous PCL material. The porous PCL material was then immersed in a 50% acetone solution (washing liquid) for 2 hours, and then washed with clean water and dried to obtain the final flat film-shaped porous PCL material. The flat film-shaped porous PCL material obtained was tested by the water permeation test to confirm that the PCL flat film was a material having an interconnected pore structure.

TABLE 7

| | | | Pore structure |
|---|---|---|---|
| | | Coagulating | of porous |
| Specimen | Coagulant | time (hr) | matrix |
| 7A | 40 wt % | 4 | interconnected |
| | acetone | | |
| 7B | 40 wt % | 4 | interconnected |
| | ethanol | | |
| 7C | 60 wt % | 4 | interconnected |
| | ethanol | | |
| 7D | 20 wt % DMF | 4 | interconnected |

### EXAMPLE 8

15 g of polycaprolactone (PCL) having a molecular weight about 80,000 and 15 g of polycaprolactone triol (PCLTL) having a molecular weight of 300 (an oligomer) were added to 70 g of DMF, which was stirred thoroughly at room temperature to form a PCL solution. The solution was then coated onto the surface of a plate-shaped mold to a thickness of about 0.2 mm. The plate-shaped mold coated with PCL solution was then placed in a coagulant at 20° C. (the composition of the coagulant and coagulating time are shown in Table 8). Thus, the PCL solution was coagulated to form a porous PCL material. The porous PCL material was then immersed in a 50% acetone solution (washing liquid) for 2 hours, and then washed with clean water and dried to obtain the final flat film-shaped porous PCL material. The flat film-shaped porous PCL material obtained was tested by the water permeation test to confirm that the PCL flat film was a material having an interconnected pore structure.

TABLE 8

| | | | Pore structure |
|---|---|---|---|
| | | Coagulating | of porous |
| Specimen | Coagulant | time (hr) | matrix |
| 8A | 40 wt % | 1 | Interconnected |
| | acetone | | |
| 8B | 40 wt % | 1 | interconnected |
| | ethanol | | |
| 8C | 60 wt % | 1 | interconnected |
| | ethanol | | |
| 8D | 20 wt % DMF | 1 | interconnected |

### EXAMPLE 9

15 g of polycaprolactone (PCL) having a molecular weight about 80,000 and 15 g of polycaprolactone diol (PCLDL) having a molecular weight of 1250 (an oligomer) were added to 70 g of DMF, which was stirred thoroughly at room temperature to form a PCL solution. The solution was then coated onto the surface of a plate-shaped mold to a thickness of about 0.4 mm. The plate-shaped mold coated with PCL solution was then placed in a coagulant at 20° C. (the composition of the coagulant and coagulating time are shown in Table 9). Thus, the PCL solution was coagulated to form a porous PCL material. The porous PCL material was then immersed in a 50% acetone solution (washing liquid) for 2 hours, and then washed with clean water and dried to obtain the final flat film-shaped porous PCL material. The flat film-shaped porous PCL material obtained was tested by the water permeation test to confirm that the PCL flat film was a material having an interconnected pore structure.

TABLE 9

| | | | Pore structure |
|---|---|---|---|
| | | Coagulating | of porous |
| Specimen | Coagulant | time (hr) | matrix |
| 9A | 40 wt % | 4 | interconnected |
| | acetone | | |
| 9B | 40 wt % | 4 | interconnected |
| | ethanol | | |
| 9C | 60 wt % | 4 | interconnected |
| | ethanol | | |
| 9D | 20 wt % DMF | 4 | interconnected |

### EXAMPLE 10

15 g of polycaprolactone (PCL) having a molecular weight about 80,000 and 15 g of polycaprolactone diol (PCLDL) having a molecular weight of 1250 (an oligomer) were added to 70 g of THF, which was stirred thoroughly at room temperature to form a PCL solution. The solution was then coated onto the surface of a plate-shaped mold to a thickness of about 0.5 mm. The plate-shaped mold coated with PCL solution was then placed in a coagulant at 20° C. (the composition of the coagulant and coagulating time are shown in Table 10). Thus, the PCL solution was coagulated to form a porous PCL material. The porous PCL material was then immersed in a 50% acetone solution (washing liquid) for 4 hours, and then washed with clean water and dried to obtain the final flat film-shaped porous PCL material. The flat film-shaped porous PCL material obtained was tested by the water permeation test to confirm that the PCL flat film was a material having an interconnected pore structure.

TABLE 10

| | | | Pore structure |
|---|---|---|---|
| | | Coagulating | of porous |
| Specimen | Coagulant | time (hr) | matrix |
| 10A | 40 wt % | 24 | interconnected |
| | acetone | | |
| 10B | 40 wt % | 24 | interconnected |
| | ethanol | | |
| 10C | 20 wt % DMF | 24 | interconnected |

### EXAMPLE 11

15 g of polycaprolactone (PCL) having a molecular weight about 80,000 and 15 g of polyethylene glycol (PEG) having a molecular weight of 1250 (an oligomer) were added to 70 g of THF, which was stirred thoroughly at room temperature to form a PCL solution. The solution was then coated onto the surface of a plate-shaped mold to a thickness of about 0.4 mm. The plate-shaped mold coated with PCL solution was then placed in a coagulant at 20° C. (the composition of the coagulant and coagulating time are shown in Table 11). Thus, the PCL solution was coagulated to form a porous PCL material. The porous PCL material was then immersed in a 40% acetone solution (washing liquid) for 4 hours, and then washed with clean water and dried to obtain the final flat film-shaped porous PCL material. The flat film-shaped porous PCL material obtained was tested by the water permeation test to confirm that the PCL flat film was a material having an interconnected pore structure.

TABLE 11

| | | | Pore structure |
|---|---|---|---|
| | | Coagulating | of porous |
| Specimen | Coagulant | time (hr) | matrix |
| 11A | 40 wt % | 24 | interconnected |
| | ethanol | | |

### EXAMPLE 12

15 g of polycaprolactone (PCL) having a molecular weight about 80,000, 7 g of polycaprolactone triol (PCLTL) having a molecular weight of 300 (an oligomer), and 8 g of polyethylene glycol (PEG) having a molecular weight of 300 were added to 55 g of DMF, which was stirred thoroughly at room temperature to form a PCL solution. The solution was then coated onto the surface of a plate-shaped mold to a thickness of about 0.4 mm. The plate-shaped mold coated with PCL solution was then placed in a coagulant at 20° C. (the composition of the coagulant and coagulating time are shown in Table 12). Thus, the PCL solution was coagulated to form a porous PCL material. The porous PCL material was then immersed in a 50% acetone solution (washing liquid) for 4 hours, and then washed with clean water and dried to obtain the final flat film-shaped porous PCL material. The flat film-shaped porous PCL material obtained was tested by the water permeation test to confirm that the PCL flat film was a material having an interconnected pore structure.

TABLE 12

| | | | Pore structure |
|---|---|---|---|
| | | Coagulating | of porous |
| Specimen | Coagulant | time (hr) | matrix |
| 12A | 40 wt % | 3 | Interconnected |
| | acetone | | |
| 12B | 40 wt % | 3 | Interconnected |
| | ethanol | | |
| 12C | 20 wt % DMF | 3 | Interconnected |

### EXAMPLE 13

15 g of polycaprolactone (PCL) having a molecular weight about 80,000 and 15 g of polycaprolactone triol (PCLTL) having a molecular weight of 300 (an oligomer) were added to a mixed organic solvent containing 35 g of DMF and 35 g of THF, which was stirred thoroughly at room temperature to form a PCL solution. The solution was then coated onto the surface of a plate-shaped mold to a thickness of about 0.4 mm. The plate-shaped mold coated with PCL solution was then placed in a coagulant at 20° C. (the composition of the coagulant and coagulating time are shown in Table 13). Thus, the PCL solution was coagulated to form a porous PCL material. The porous PCL material was then immersed in a 50% acetone solution (washing liquid) for 4 hours, and then washed with clean water and dried to obtain the final flat film-shaped porous PCL material. The flat film-shaped porous PCL material obtained was tested by the water permeation test to confirm that the PCL flat film was a material having an interconnected pore structure.

TABLE 13

| | | | Pore structure |
|---|---|---|---|
| | | Coagulating | of porous |
| Specimen | Coagulant | time (hr) | matrix |
| 13A | 40 wt % | 4 | interconnected |
| | acetone | | |
| 13B | 40 wt % | 4 | interconnected |
| | ethanol | | |
| 13C | 20 wt % DMF | 4 | interconnected |

### EXAMPLE 14

15 g of polycaprolactone (PCL) having a molecular weight about 80,000 and 15 g of polycaprolactone triol (PCLTL) having a molecular weight of 300 (an oligomer) were added to a mixed organic solvent containing 55 g of DMF and 15 g of ethanol, which was stirred thoroughly at room temperature to form a PCL solution. The solution was then coated onto the surface of a plate-shaped mold to a thickness of about 4 mm. The plate-shaped mold coated with PCL solution was then placed in a coagulant at 20° C. (the composition of the coagulant and coagulating time are shown in Table 14). Thus, the PCL solution was coagulated to form a porous PCL material. The porous PCL material was then immersed in a 50% acetone solution (washing liquid) for 4 hours, and then washed with clean water and dried to obtain the final flat film-shaped porous PCL material. The flat film-shaped porous PCL material obtained was tested by the water permeation test to confirm that the PCL flat film was a material having an interconnected pore structure.

TABLE 14

| | | | Pore structure |
|---|---|---|---|
| | | Coagulating | of porous |
| Specimen | Coagulant | time (hr) | matrix |
| 14A | 40 wt % | 4 | interconnected |
| | acetone | | |
| 14B | 40 wt % | 4 | interconnected |
| | ethanol | | |
| 14C | 20 wt % DMF | 4 | interconnected |

### EXAMPLE 15

15 g of polycaprolactone (PCL) having a molecular weight about 80,000 and 10 g of polycaprolactone triol (PCLTL) having a molecular weight of 300 (an oligomer) were added to 75 g of THF, which was stirred thoroughly to form a PCL solution labeled as 15A. 15 g of PCL having a molecular weight about 80,000 and 20 g of PCLTL having a molecular weight of 300 (an oligomer) were added to 65 g of THF, which was stirred thoroughly to form a PCL solution labeled to 15B. 15 g of PCL having a molecular weight about 80,000 and 30 g of PCLTL having a molecular weight of 300 (an oligomer) were added to 45 g of THF, which was stirred thoroughly to form a PCL solution labeled to 15C. Each solution was then coated onto the surface of a plate-shaped mold to a thickness of about 3 mm. The plate-shaped mold coated with PCL solution was then placed in a coagulant at 20° C. (the composition of the coagulant and coagulating time are shown in Table 15). Thus, the PCL solution was coagulated to form a porous PCL material. The porous PCL material was then immersed in a 50% acetone solution (washing liquid) for 4 hours, and then washed with clean water and dried to obtain the final flat film-shaped porous PCL material. The flat film-shaped porous PCL materials (15A, 15B, and 15C) obtained were tested by the water permeation test to confirm that the PCL flat films were materials having an interconnected pore structure.

Specimens 15B and 15C were observed by SEM (scanning electron microscope) to doubly assure that the PCL flat films obtained were materials having an interconnected pore structure.

TABLE 15

| | | Coagulating | Porous structure | |
|---|---|---|---|---|
| Specimen | Coagulant | time (hr) | of porous matrix | SEM photo |
| 15A | 40 wt % | 12 | interconnected | — |
| | acetone | | | |
| 15B | 40 wt % | 12 | interconnected | |
| | acetone | | | |
| 15C | 40 wt % | 12 | interconnected | |
| | acetone | | | |

### EXAMPLE 16

15 g of polycaprolactone (PCL) having a molecular weight about 80,000 and 30 g of polycaprolactone triol (PCLTL) having a molecular weight of 300 (an oligomer) were added to 45 g of DMF, which was stirred thoroughly at room temperature to form a PCL solution. The solution was then coated onto the surface of a plate-shaped mold to a thickness of about 2 mm. The plate-shaped mold coated with PCL solution was then placed in a coagulant at 20° C. (the composition of the coagulant and coagulating time are shown in Table 16). Thus, the PCL solution was coagulated to form a porous PCL material. The porous PCL material was then immersed in a 50% acetone solution (washing liquid) for 4 hours, and then washed with clean water and dried to obtain the final flat film-shaped porous PCL material. The flat film-shaped porous PCL material obtained was tested by the water permeation test to confirm that the PCL flat film was a material having an interconnected pore structure.

TABLE 16

| | | | Pore structure |
|---|---|---|---|
| | | Coagulating | of porous |
| Specimen | Coagulant | time (hr) | matrix |
| 16A | 40 wt % | 6 | interconnected |
| | acetone | | |
| 16B | 40 wt % | 6 | interconnected |
| | ethanol | | |
| 16C | 20 wt % DMF | 6 | interconnected |

### EXAMPLE 17

15 g of polycaprolactone (PCL) having a molecular weight about 80,000 and 30 g of polycaprolactone triol (PCLTL) having a molecular weight of 300 (an oligomer) were added to 45 g of THF, which was stirred thoroughly at room temperature to form a PCL solution. The solution was then coated onto the surface of a plate-shaped mold to a thickness of about 2 mm. The plate-shaped mold coated with PCL solution was then placed in a coagulant at 20° C. (the composition of the coagulant and coagulating time are shown in Table 17). Thus, the PCL solution was coagulated to form a porous PCL material. The porous PCL material was then immersed in a 50% acetone solution (washing liquid) for 4 hours, and then washed with clean water and dried to obtain the final flat film-shaped porous PCL material. The flat film-shaped porous PCL material obtained was tested by the water permeation test to confirm that the PCL flat film was a material having an interconnected pore structure.

TABLE 17

| | | | Pore structure |
|---|---|---|---|
| | | Coagulating | of porous |
| Specimen | Coagulant | time (hr) | matrix |
| 17A | 40 wt % | 6 | interconnected |
| | acetone | | |
| 17B | 40 wt % | 6 | interconnected |
| | ethanol | | |
| 17C | 20 wt % DMF | 6 | interconnected |

### EXAMPLE 18

30 g of polycaprolactone (PCL) having a molecular weight about 30,000 and 15 g of polycaprolactone triol (PCLTL) having a molecular weight of 300 (an oligomer) were added to 55 g of DMF, which was stirred thoroughly at room temperature to form a PCL solution. The solution was then coated onto the surface of a plate-shaped mold to a thickness of about 2 mm. The plate-shaped mold coated with PCL solution was then placed in a coagulant at 20° C. (the composition of the coagulant and coagulating time are shown in Table 18). Thus, the PCL solution was coagulated to form a porous PCL material. The porous PCL material was then immersed in a 50% acetone solution (washing liquid) for 4 hours, and then washed with clean water and dried to obtain the final flat film-shaped porous PCL material. The flat film-shaped porous PCL material obtained was tested by the water permeation test to confirm that the PCL flat film was a material having an interconnected pore structure.

TABLE 18

| | | | Pore structure |
|---|---|---|---|
| | | Coagulating | of porous |
| Specimen | Coagulant | time (hr) | matrix |
| 18A | 40 wt % | 8 | interconnected |
| | acetone | | |
| 18B | 40 wt % | 8 | interconnected |
| | ethanol | | |
| 18C | 20 wt % DMF | 8 | interconnected |

### EXAMPLE 19

30 g of 75/25 PCL-PLA copolymer (polycaprolactone-polylactic acid copolymer) (a bioresorbable polymer) and 15 g of polycaprolactone triol (PCLTL) having a molecular weight of 300 (an oligomer) were added to 55 g of THF, which was stirred thoroughly at room temperature to form a PCL-PLA solution. The solution was then coated onto the surface of a plate-shaped mold to a thickness of about 0.4 mm. The plate-shaped mold coated with PCL-PLA solution was then placed in a coagulant at 20° C. (the composition of the coagulant and coagulating time are shown in Table 19). Thus, the PCL-PLA solution was coagulated to form a porous PCL-PLA material. The porous PCL-PLA material was then immersed in a 50% acetone solution (washing liquid) for 4 hours, and then washed with clean water and dried to obtain the final flat film-shaped porous PCL-PLA material. The flat film-shaped porous PCL-PLA material obtained was tested by the water permeation test to confirm that the PCL-PLA flat film was a material having an interconnected pore structure.

TABLE 19

| | | | Pore structure |
|---|---|---|---|
| | | Coagulating | of porous |
| Specimen | Coagulant | time (hr) | matrix |
| 19A | 40 wt % | 12 | interconnected |
| | acetone | | |
| 19B | 40 wt % | 12 | interconnected |
| | ethanol | | |
| 19C | 20 wt % DMF | 12 | interconnected |

### EXAMPLE 20

10 g of PLA having a molecular weight of 1,000,000 and 5 g of PCLTL (polycaprolactone triol) having a molecular weight of 300 were added to 85 g of dichloromethane, which was stirred thoroughly at room temperature to form a PLA solution. The solution was then coated onto the surface of a plate-shaped mold to a thickness of about 3 mm. The plate-shaped mold coated with PLA solution was then held still in air at 25±2° C. for 5 minutes to evaporate the solvent on the surface, which was then placed in a coagulant at 20° C. (the composition of the coagulant and coagulating time are shown in Table 20). Thus, the PLA solution was coagulated to form a porous PLA material. The porous PLA material was then immersed in a 50% acetone solution (washing liquid) for 4 hours, and then washed with clean water and dried to obtain the final flat film-shaped porous PLA material. The flat film-shaped porous PLA material obtained was tested by the water permeation test to confirm that the PLA flat film was a material having an interconnected pore structure.

TABLE 20

| | | | Pore structure |
|---|---|---|---|
| | | Coagulating | of porous |
| Specimen | Coagulant | time (hr) | matrix |
| 20A | 40 wt % | 12 | interconnected |
| | acetone | | |
| 20B | 40 wt % | 12 | interconnected |
| | ethanol | | |
| 20C | 20 wt % DMF | 12 | interconnected |

### EXAMPLE 21

15 g of bioresorbable polymer PLGA and 15 g of oligomer PCLTL (polycaprolactone triol) having a molecular weight of 300 were added to 70 g of THF, which was stirred thoroughly at room temperature to form a PLGA solution. The PLGA solution was then coated onto the surface of a plate-shaped mold to a thickness of about 2 mm. The plate-shaped mold coated with PLGA solution was then placed in a coagulant at 20° C. (the composition of the coagulant and coagulating time are shown in Table 21). Thus, the PLGA solution was coagulated to form a porous PLGA material. The porous PLGA material was then immersed in a 50% acetone solution (washing liquid) for 4 hours, and then washed with clean water and dried to obtain the final flat film-shaped porous PLGA material. The flat film-shaped porous PLGA material obtained was tested by the water permeation test to confirm that the PLGA flat film was a material having an interconnected pore structure.

TABLE 21

| | | | Pore structure |
|---|---|---|---|
| | | Coagulating | of porous |
| Specimen | Coagulant | time (hr) | matrix |
| 21A | 40 wt % | 12 | interconnected |
| | acetone | | |
| 21B | 40 wt % | 12 | interconnected |
| | ethanol | | |
| 21C | 20 wt % DMF | 12 | interconnected |

### EXAMPLE 22

PCL (polycaprolactone) having a molecular weight about 80,000 and PLA (polylactide) having a molecular weight about 500,000 were mixed to form a polymer blend (the PCL/PLA mixing ratio is shown in Table 22), which was then dissolved in dichloromethane. PEG (polyethylene glycol, low molecular weight oligomer) having a molecular weight about 300 was then added to the above solution and stirred thoroughly to form a homogeneous blend solution.

The blend solution was then coated onto the surface of a plate-shaped mold to a thickness of about 2 mm. The plate-shaped mold coated with PCL/PLA solution was then held still in air at 25±2° C. for drying to evaporate the solvent on the surface. The blended solution was tested for tack free time according to the ASTM C697-87(1997) method. The results are shown in Table 23.

TABLE 22
PCL, PLA/oligomer/solvent
15/15/70

| component | | | | |
|---|---|---|---|---|
| Blending | | | | |
| Ratio | PCL | PLA | PEG₃₀₀ | Dichloromethane |
| 70/30 | 10.5% | 4.5% | 15% | 70% |

TABLE 23
PCL, PLA/oligomer/solvent
15/15/70

| Result (25° C.) | |
|---|---|
| drying time | tacky on the surface (+) |
| (min) | tack free surface (−) |
| 0.5 | + |
| 1 | + |
| 2 | + |
| 3 | + |
| 4 | − |
| 5 | − |
| 6 | − |
| 7 | − |
| 8 | − |
| 9 | − |
| 10 | − |

### EXAMPLE 23

PCL (polycaprolactone) having a molecular weight about 80,000 and PLA (polylactide) having a molecular weight about 500,000 were mixed to form a polymer blend (the PCL/PLA mixing ratio is shown in Table 24), which was then dissolved in dichloromethane. PEG (polyethylene glycol, low molecular weight oligomer) having a molecular weight about 300 was then added to the above solution and stirred thoroughly to form a homogeneous blend solution.

The blend solution was then coated onto the surface of a plate-shaped mold to a thickness of about 3 mm. The plate-shaped mold coated with PCL/PLA solution was solidified at 25±2° C. in various conditions (the solidifying conditions are shown in Table 25) to evaporate the surface solvent and coagulate. Next, the solution was placed in a 40 wt % acetone coagulant at 20° C. for 4 hours to form a porous material.

The porous PCL/PLA material was then immersed in a 50% acetone solution (washing liquid) for 4 hours, and then washed with clean water and dried to obtain the final flat film-shaped porous PCL/PLA polymer blend material. The flat film-shaped porous PCL/PLA polymer blend material obtained was tested by the water permeation test to confirm that the PCL/PLA flat film was a material having an interconnected pore structure.

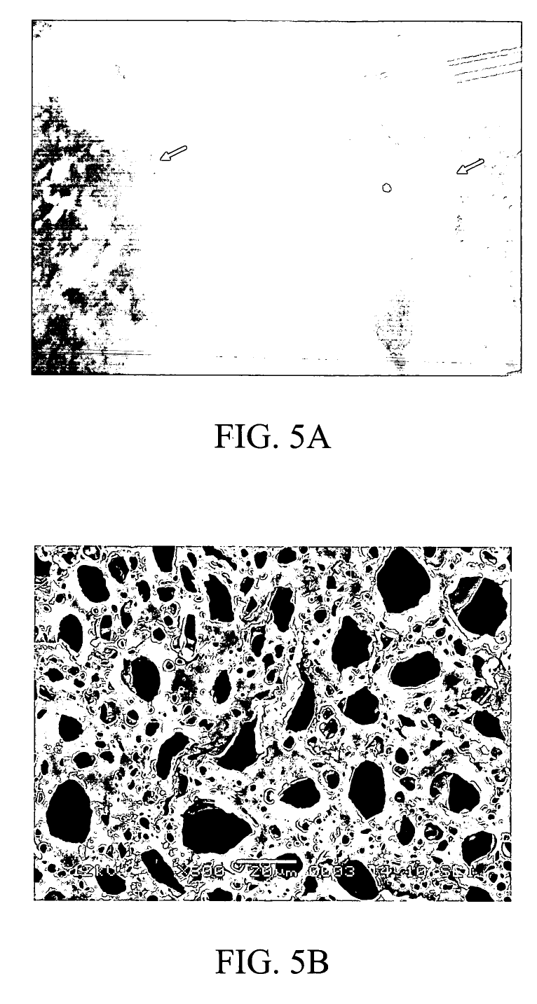

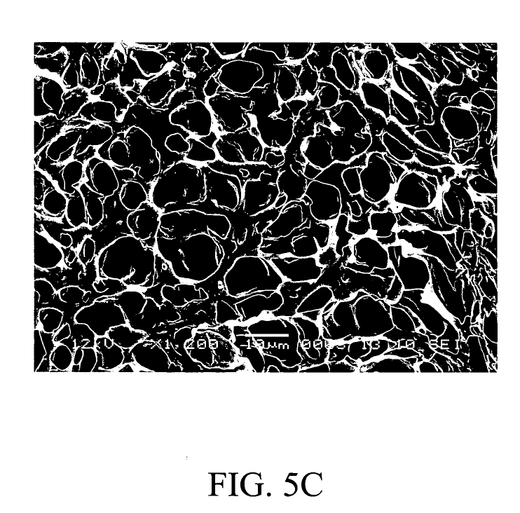

Specimen #23A was the blended solution untreated by surface solidification and could not be coagulated to form a film as shown in FIG. 5A. Specimens #23B, #23C, #23D, and #23E were treated by surface solidification and FIGS. 5B and 5C (SEM photographs) further confirm that the PCL/PLA polymer blend flat films are materials with interconnected pore structures.

TABLE 24
PCL, PLA/oligomer/solvent
15/15/70

| component | | | | |
|---|---|---|---|---|
| Blending | | | | |
| Ratio | PCL | PLA | PEG₃₀₀ | Dichloromethane |
| 70/30 | 10.5% | 4.5% | 15% | 70% |

TABLE 25
PCL, PLA/oligomer/solvent
15/15/70

| Result | | |
|---|---|---|
| surface solidification | | |
| time (min) | SEM photo | Specimen No. |
| 0 | | 23A |
| 2 | — | 23B |
| 5 | | 23C |
| 10 | — | 23D |
| 15 | | 23E |
| (solvent is completely | | |
| removed) | | |

### EXAMPLE 24

PCL (polycaprolactone) having a molecular weight about 80,000 and PLA (polyactide) having a molecular weight about 500,000 were mixed to form a polymer blend (the PCL/PLA mixing ratio is shown in Table 26), which was then dissolved in dichloromethane. PEG (polyethylene glycol, low molecular weight oligomer) having a molecular weight about 300 was then added to the above solution and stirred thoroughly to form a homogeneous blended solution.

The blend solution was then coated onto the surface of a plate-shaped mold to a thickness of about 3 mm. The plate-shaped mold coated with PCL/PLA solution was then held still in air at 30±2° C. for 5 minutes to evaporate the surface solvent and coagulate. Next, the solution was placed in a 40 wt % acetone coagulant at 20° C. for 4 hours to form a porous material.

The porous PCL/PLA material was then immersed in a 50% acetone solution (washing liquid) for 4 hours, and then washed with clean water and dried to obtain the final flat film-shaped porous PCL/PLA polymer blend material. The flat film-shaped porous PCL/PLA polymer blend material obtained was tested by the water permeation test to confirm that the PCL/PLA flat film was a material having an interconnected pore structure.

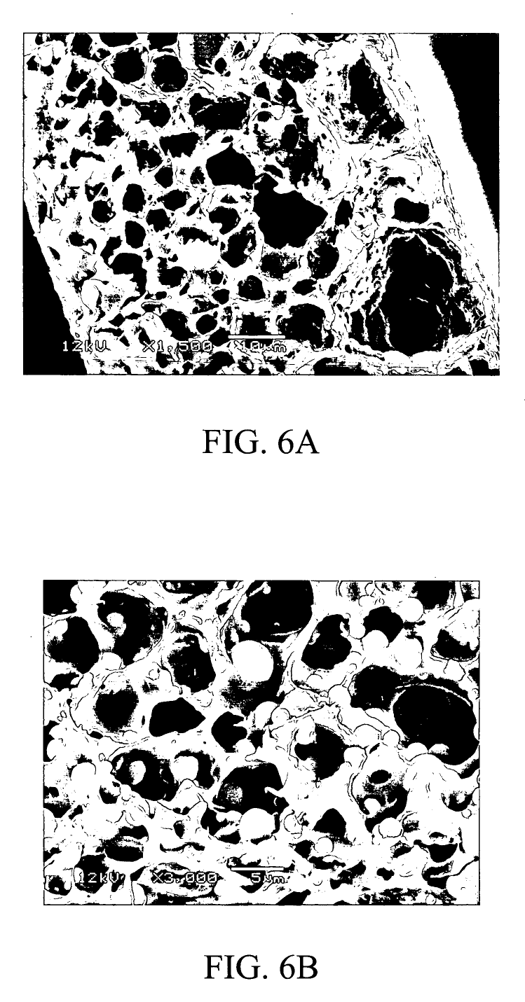

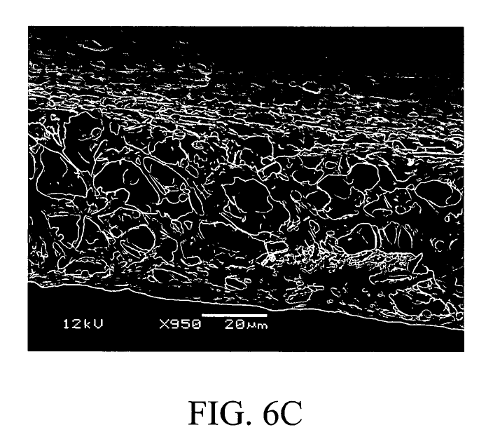

Specimens #24A, #24D, and #24E were observed by SEM (FIGS. 6A, 6B, and 6C) to doubly assure that the PCL/PLA flat films obtained were materials with interconnected pore structures.

TABLE 26
PCL, PLA/oligomer/solvent
15/15/70

| component | | | | | | |
|---|---|---|---|---|---|---|
| blending | | | | Dichloro- | SEM | |
| ratio | PCL | PLA | PEG₃₀₀ | methane | photo | specimen |
| 90/10 | 13.5% | 1.5% | 15% | 70% | | 24A |
| 80/20 | 12% | 3% | 15% | 70% | — | 24B |
| 70/30 | 10.5% | 4.5% | 15% | 70% | — | 24C |
| 60/40 | 9% | 6% | 15% | 70% | | 24D |
| 50/50 | 7.5% | 4.5% | 15% | 70% | | 24E |

### EXAMPLE 25

PCL (polycaprolactone) having a molecular weight about 80,000 and PLGA (poly-lactic-co-glycolic acid) having a molecular weight about 150,000 were mixed to form a polymer blend(the PCL/PLGA blending ratio is shown in Table 27), which was then dissolved in dichloromethane. PEG (polyethylene glycol, low molecular weight oligomer) having a molecular weight about 300 was then added to the above solution and stirred thoroughly to form a homogeneous blend solution.

The blend solution was then coated onto the surface of a plate-shaped mold to a thickness of about 3 mm. The plate-shaped mold coated with PCL/PLGA solution was then held still in air at 15±2° C. for 5 minutes to evaporate the surface solvent and coagulate. Next, the solution was placed in a 40 wt % acetone coagulant at 20° C. for 4 hours to form a porous material.

The porous PCL/PLGA material was then immersed in a 50% acetone solution (washing liquid) for 4 hours, and then washed with clean water and dried to obtain the final flat film-shaped porous PCL/PLGA polymer blend material. The flat film-shaped porous PCL/PLGA polymer blend material obtained was tested by the water permeation test to confirm that the PCL/PLGA flat film was a material having an interconnected pore structure.

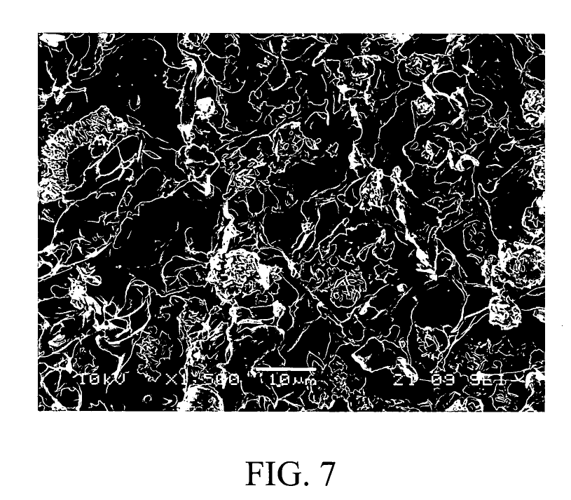

Specimen #25A was observed by SEM (FIG. 7) to doubly assure that the PCL/PLGA flat film obtained was a material having an interconnected pore structure.

TABLE 27
PCL, PLGA/oligomer/solvent
15/15/70

| component | | | | | | |
|---|---|---|---|---|---|---|
| blending | | | | Dichloro- | SEM | speci- |
| ratio | PCL | PLGA | PEG₃₀₀ | methane | photo | men |
| 70/30 | 10.5% | 4.5% | 15% | 70% | | 25A |
| 50/50 | 7.5% | 4.5% | 15% | 70% | — | 25B |

The foregoing description of the preferred embodiments of this invention has been presented for purposes of illustration and description. Obvious modifications or variations are possible in light of the above teaching. The embodiments chosen and described provide an excellent illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A process for preparing a porous material having interconnected pores, comprising the following steps:
dissolving one or more kinds of bioresorbable polymers and a low molecular weight oligomer in an organic solvent to form a bioresorbable polymer solution; and
a coagulating step: exposing the bioresorbable polymer solution to a coagulant to form the porous material, wherein the low molecular weight oligomer is soluble in the coagulant, and the bioresorbable polymer is insoluble in the coagulant.

2. The process as claimed in claim 1, before the coagulating step, further comprising a step of making the bioresorbable polymer solution to form a pre-form.

3. The process as claimed in claim 2, wherein the pre-form forming step includes coating the bioresorbable solution onto a mold surface.

4. The process as claimed in claim 2, wherein the pre-form forming step includes pouring the bioresorbable solution into a container.

5. The process as claimed in claim 2, further comprising a step of drying the pre-form to partially or completely remove the organic solvent on the pre-form surface.

6. The process as claimed in claim 5, wherein the drying step makes the pre-form form a gel surface or a tack-free surface.

7. The process as claimed in claim 5, wherein the drying step is conducted in air at room temperature, by heating, in an oven, at a reduced pressure, or by radiation.

8. The process as claimed in claim 1, wherein the bioresorbable polymer has a molecular weight of 20,000 to 1,500,000.

9. The process as claimed in claim 1, wherein the bioresorbable polymer is polycaprolactone (PCL), polylactic acid (PLA), poly-L-lactide (PLLA), polyglycolic acid (PGA), poly-lactic-co-glycolic acid copolymer (PLGA copolymer), polycaprolactone-polylactic acid copolymer (PCL-PLA copolymer), polycaprolactone-polyethylene glycol copolymer (PCL-PEG copolymer), or mixtures thereof.

10. The process as claimed in claim 9, wherein the bioresorbable polymer is a mixture of PCL and PLA.

11. The process as claimed in claim 9, wherein the bioresorbable polymer is a mixture of PCL and PLGA copolymer.

12. The process as claimed in claim 1, wherein the low molecular weight oligomer has a molecular weight of 200 to 10,000.

13. The process as claimed in claim 12, wherein the low molecular weight oligomer has a molecular weight of 200 to 5000.

14. The process as claimed in claim 1, wherein the low molecular weight oligomer is polycaprolactone triol (PCLTL), polycaprolactone diol (PCLDL), polycaprolactone (PCL), polylactic acid (PLA), polyethylene glycol (PEG), polypropylene glycol (PPG), polytetramethylene glycol (PTMG), or mixtures thereof.

15. The process as claimed in claim 1, wherein the organic solvent for dissolving the bioresorbable polymer and the low molecular weight oligomer is N,N-dimethylformamide (DMF), N,N-dimethylacetamide (DMAc), tetrahydrofuran (THF), an alcohol, chloroform, dichloromethane (DCM), 1,4-dioxane, or mixtures thereof.

16. The process as claimed in claim 1, wherein the bioresorbable polymer is present in an amount of 5-70% weight fraction of the bioresorbable polymer solution.

17. The process as claimed in claim 16, wherein the bioresorbable polymer is present in an amount of 10-50% weight fraction of the bioresorbable polymer solution.

18. The process as claimed in claim 1, wherein the low molecular weight oligomer is present in an amount of 10-80% weight fraction based on the non-solvent portion of the bioresorbable polymer solution.

19. The process as claimed in claim 1, wherein the coagulant is water, an organic solvent, a mixture of water and an organic solvent, or a mixture of organic solvents.

20. The process as claimed in claim 19, wherein the coagulant is a mixture of water and an organic solvent and the organic solvent is present in an amount of 5-90% weight fraction.

21. The process as claimed in claim 20, wherein the organic solvent in the coagulant is an amide, a ketone, an alcohol, or a mixture thereof.

22. The process as claimed in claim 21, wherein the organic solvent in the coagulant includes a ketone and an alcohol.

23. The process as claimed in claim 1, wherein the step of exposing the bioresorbable polymer solution to a coagulant is performed at a temperature of 5° C. to 60° C.

24. The process as claimed in claim 23, wherein the step of exposing the bioresorbable polymer solution to a coagulant is performed at a temperature of 10° C. to 50° C.

25. The process as claimed in claim 1, after the bioresorbable polymer solution is exposed to the coagulant, further comprising washing the porous bioresorbable material in a washing liquid.

26. The process as claimed in claim 25, wherein the washing liquid is water, an organic solvent, a mixture of water and an organic solvent, or a mixture of organic solvents and the organic solvent in the washing liquid is a ketone, an alcohol, or a mixture thereof.

27. A process for preparing a porous material having interconnected pores, comprising the following steps:
dissolving one or more kinds of bioresorbable polymers and a low molecular weight oligomer in an organic solvent to form a bioresorbable polymer solution;
making the bioresorbable polymer solution to form a pre-form;
drying the pre-form to partially or completely remove the organic solvent on the pre-form surface; and
exposing the pre-form to a coagulant to form the porous material, wherein the low molecular weight oligomer is soluble in the coagulant and the bioresorbable polymer is insoluble in the coagulant.
